(19) United States
(12) Patent Application Publication
(10) Pub. No.: US 2011/0123665 A1
(43) Pub. Date: May 26, 2011

(54) IMPRINT BLANK, IMPRINT TEMPLATE AND METHOD FOR MANUFACTURING THE SAME

(76) Inventor: Masatoshi TERAYAMA, Kanagawa-ken (JP)

(21) Appl. No.: 12/886,406

(22) Filed: Sep. 20, 2010

(30) Foreign Application Priority Data
Nov. 20, 2009 (JP) 2009-265221

(51) Int. Cl. B29C 59/02; B05D 3/00; C23F 1/00; C23F 1/02; C23F 1/12; B32B 9/04

(52) U.S. Cl. 425/385; 427/532; 216/62; 428/688

(57) ABSTRACT

According to one embodiment, an imprint blank includes a substrate layer and a plurality of diamond-like carbon layers. The plurality of diamond-like carbon layers are stacked on the substrate layer, and have a mixture ratio of carbon atoms forming sp² hybrid orbitals to carbon atoms forming sp³ hybrid orbitals differing between adjacent layers in a stacking direction.

### CROSS-REFERENCE TO RELATED APPLICATION

This application is based upon and claims the benefit of priority from Japanese Patent Application No. 2009-265221, filed on Nov. 20, 2009; the entire contents of which are incorporated herein by reference.

### FIELD

Embodiments described herein relate generally to an imprint blank, imprint template and a method for manufacturing the same.

### BACKGROUND

Diamond-like carbon is expected to have applications in imprint templates due to high levels of hardness and a low friction coefficient. For instance, JP-A 2009-149097 discloses forming a recess and protrusion pattern on a surface of a metal body, and forming a diamond-like carbon film on a surface of the body where the recess and protrusion pattern is formed.

However, in this case, it is very difficult to form the diamond-like carbon film with film thickness controlled to high precision on the surface where the recess and protrusion pattern is formed as the recess and protrusion pattern becomes fine.

### BRIEF DESCRIPTION OF THE DRAWINGS

FIGS. 1A to 1D are schematic cross-sectional views showing a method for manufacturing an imprint template according to an embodiment;

FIGS. 2A to 2D are schematic cross-sectional views showing a method for manufacturing a semiconductor device based on the imprint template according to the embodiment;

FIG. 3A is an example of an energy spectrum of Auger electrons measured at irradiation of a second diamond-like carbon layer in FIG. 1A with an electron beam, FIG. 3B is an example of an energy spectrum of Auger electrons measured at irradiation of a first diamond-like carbon layer in FIG. 1A with an electron beam;

FIGS. 4A and 4B are schematic cross-sectional views of the imprint blank and the imprint template according to another embodiment.

### DETAILED DESCRIPTION

According to one embodiment, an imprint blank includes a substrate layer and a plurality of diamond-like carbon layers. The plurality of diamond-like carbon layers are stacked on the substrate layer, and have a mixture ratio of carbon atoms forming sp² hybrid orbitals to carbon atoms forming sp³ hybrid orbitals differing between adjacent layers in a stacking direction.

Embodiments of the invention will be described below with reference to the drawings.

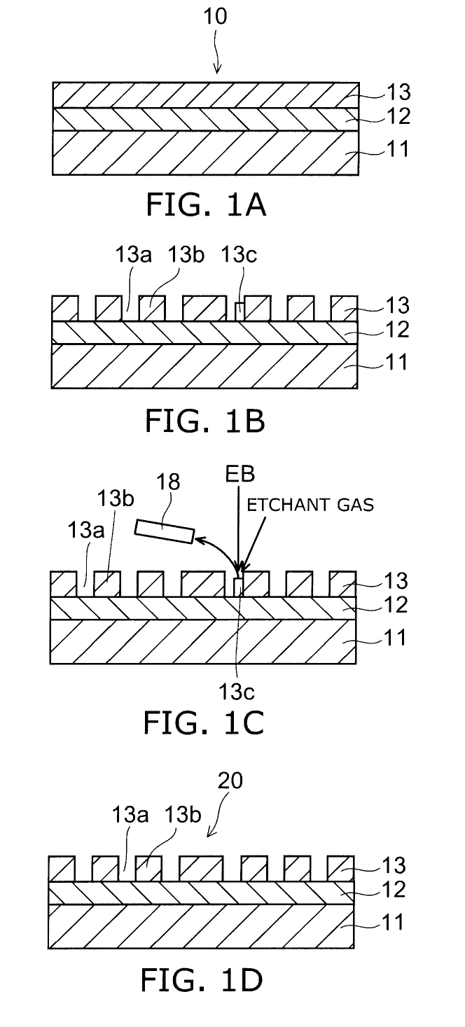

FIG. 1A is a schematic cross-sectional view of an imprint blank (hereinafter referred to as “blank”) 10 according to this embodiment.

The blank 10 has a structure with a plurality of diamond-like carbon layers stacked on a substrate layer 11. The substrate layer 11 is, for instance, a quartz substrate. The plurality of diamond-like carbon layers has a first diamond-like carbon layer 12 and a second diamond-like carbon layer 13.

The diamond-like carbon includes carbon atoms bonded through the formation of sp² hybrid orbitals (sp²-bonded carbon) and carbon atoms bonded through the formation of sp³-hybrid orbitals (sp³-bonded carbon). In this embodiment, a mixture ratio of the sp²-bonded carbon atoms to the sp³-bonded carbon atoms differs between adjacent layers in a stacking direction in the plurality of diamond-like carbon layers. For example, in the first diamond-like carbon layer 12, the sp²-bonded carbon atom content is greater than the sp³-bonded carbon atom content, making the first diamond-like carbon layer 12 sp²-bonded carbon rich. In the second diamond-like carbon layer 13, the mixture ratio of the sp²-bonded carbon atoms to the sp³-bonded carbon atoms is substantially 1.

The above-described mixture ratio can be controlled by adjusting conditions under which the diamond-like carbon is formed into a film using a CVD (chemical vapor deposition) method or the like. For instance, if concentrations of oxygen and hydrogen in a source material gas are relatively high, the proportion of sp³ hybrid orbitals can be increased.

An imprint template (hereinafter simply referred to as “template”) can be prepared by forming a desired recess and protrusion pattern on the blank 10 as illustrated in FIG. 1B.

The substrate layer 11 and the first diamond-like carbon layer 12 are not processed. Recesses 13a and protrusions 13b are formed in the second diamond-like carbon layer 13. The recess and protrusion pattern may, for instance, be formed by direct writing with an electron beam and subsequent development, or by selective etching using a mask.

During patterning, the second diamond-like carbon layer 13 in the recesses 13a may be left behind as a defect (black defect) 13c. In this case, a defect correction process is performed on the defect 13c.

For instance, the defect 13c may be removed by irradiation with an electron beam. At this time, to reduce damage to a layer under the defect 13c (the first diamond-like carbon layer 12 in this embodiment) caused by overetching with the electron beam, it is important to control the electron beam (mainly by controlling the duration of the irradiation) so that an irradiation dose applied with the electron beam corresponds to a height (thickness) of the defect 13c.

When constituent elements of the target defect and the layer under the defect 13c are different, it is possible to detect a timing at which the electron beam irradiation to the defect 13c is stopped by measuring an amount of emitted secondary electrons, an amount of reflected electrons, or the like. In other words, an interface (correction endpoint) between the defect 13c and the layer under the defect 13c can be detected. However, if the constituent elements of the defect 13c and the first diamond-like carbon layer 12 under the defect 13c are the same or similar as in this embodiment, detection of the correction endpoint is difficult.

In this case, data about the height of the defect 13c is necessary to control the irradiation dose applied to the defect 13c with the electron beam. However, it is difficult to measure such dimensions without sacrificing TAT (turnaround time), and much depends on the proficiency of operators that make estimates based on defect images. If the irradiation dose is too low, further correction by irradiation with the electron beam will be necessary, leading to an increase in TAT. If the irradiation dose is too high, the layer under the defect 13c may be badly damaged, making it necessary to re-manufacture the template, and thus significantly lengthening the TAT.

Besides the methods using secondary electrons and reflected electrons, methods using characteristic X-rays and Auger electrons can also be considered as methods of obtaining sample data by irradiation with the electron beam. With regard to characteristic X-ray analysis, methods such as EDS (Energy Dispersive X-ray Spectroscopy) and WDS (Wavelength-Dispersive X-ray Spectroscopy) can be considered. However, a difference in chemical bond energy between the sp²hybrid orbitals and the sp³hybrid orbitals is approximately 0.9 eV. With existing WDS energy resolutions (approximately 15 eV), it is difficult to achieve resolution.

With the characteristic X-ray analysis, since data about relatively deep positions up to a few μm below the sample surface is obtained, this method of analysis cannot be said to be sensitive to the surface, and is not appropriate for testing imprint templates which commonly have fine recess and protrusion patterns with dimension at the nm level formed on the surface. With the Auger electron analysis, on the other hand, data about the sample surface can be obtained at a depth of approximately 50 Angstroms and is sensitive to changes in the sample surface.

Hence, in this embodiment, the correction endpoint for the defect 13c is located by measuring the Auger electrons emitted as a result of irradiating with the electrode beam.

FIG. 1C shows the defect correction process performed on the defect 13c.

The defect 13c is irradiated with an electron beam EB. During this time, an etchant gas is supplied to the surface of the second diamond-like carbon layer 13 including the defect 13c. By irradiating the defect 13c with the electron beam EB, the carbon forming the defect 13c is caused to bond with the etchant gas. Consequently, this carbon is vaporized and removed.

Note that the defect 13c may also be removed though irradiation with a radiation beam other than an electron beam, such as a proton beam or the like. Irradiation with any beam is satisfactory, provided that the beam can remove the defect 13c and excite the defect 13c so as to allow Auger electrons to be emitted. In this case, the endpoint can be detected as the defect is being removed.

The irradiation of the defect 13c with the electron beam EB causes Auger electrons to be emitted. The Auger electrons are detected by an Auger electron detector 18 provided in proximity to the surface of second diamond-like carbon layer 13, and an energy spectrum of the Auger electrons is thereby acquired.

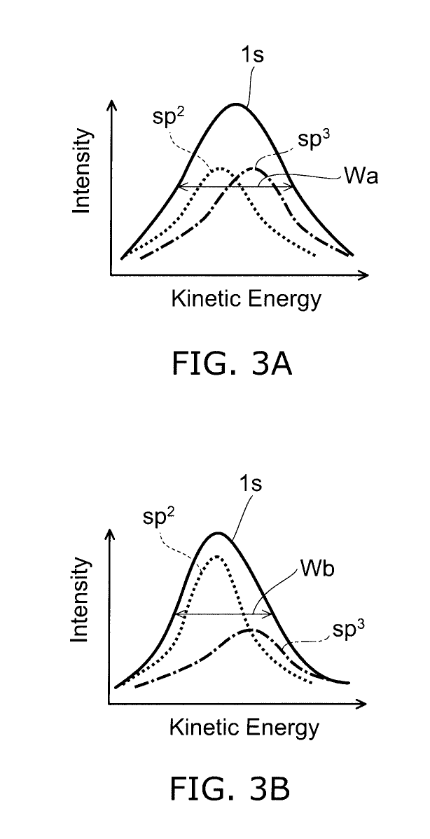

An example of an energy spectrum of the Auger electrons (Auger spectrum) is illustrated in FIG. 3A. In FIG. 3A, the horizontal axis represents kinetic energy of the Auger electrons and the vertical axis represents intensity.

By measuring the above-described Auger electrons, an energy spectrum of 1s orbitals (shown as a solid line in FIG. 3A) is obtained for the carbon contained in the portion irradiated with the electron beam EB. The energy spectrum of the 1s orbitals corresponds to a combination of an energy spectrum of the sp² hybrid orbitals (shown as a broken line in FIG. 3A) and an energy spectrum of the sp³ hybrid orbitals (shown as a dotted line in FIG. 3A).

Correlations between the mixture ratio of the sp²-bonded carbon atoms to the sp³-bonded carbon atoms and respective peak positions of the energy spectrum of the sp² hybrid orbitals and the energy spectrum of the sp³ hybrid orbitals have been found or can be calculated using other methods. Current Auger electron spectral analysis techniques, however, neither provide a resolution for direct analysis of the respective peak positions in the energy spectrum of the sp² hybrid orbitals and the energy spectrum of the sp³ hybrid orbitals, nor provide a resolution that is low. Hence, in this embodiment, the diamond-like carbon layer being irradiated with the electron beam is identified based on the energy spectrum of the is orbitals.

More specifically, changes in a peak position and a spectral width (i.e. half-width of the peak) of the energy spectrum of the 1s orbitals are monitored. The defect 13c is in the same layer as the second diamond-like carbon layer 13, and the mixture ratio of the sp² bonded carbon atoms to the sp³-bonded carbon atoms for the defect 13c is substantially 1. In this case, as illustrated in FIG. 3A, the peak position of the spectrum of the 1s orbitals is located approximately midway between the peak position of the energy spectrum of the energy spectrum of the sp² hybrid orbitals and the peak position of the energy spectrum of the sp³ hybrid orbitals.

When the defect 13c is removed and the electron beam reaches the first diamond-like carbon layer 12, which is sp²-bonded carbon rich, the peak position of the 1s orbitals shifts towards the peak position of the sp² orbitals, as illustrated in FIG. 3B. In addition, a half width Wb of the peak of the 1s orbitals is smaller than a half width Wa when the defect 13c is being irradiated with the electron beam (FIG. 3A).

By setting a threshold value for at least one of the peak position and the half width and monitoring their changes, the point at which the electron beam target shifts from the defect 13c to the first diamond-like carbon layer 12, i.e. the correction endpoint, can be detected. On detection of the endpoint, irradiation with the electron beam can be stopped. Therefore, it is possible to reduce damage to the first diamond-like carbon layer 12, which is not the target of correction.

By removing the defect 13c a template 20 illustrated in FIG. 1D can be obtained. According to this embodiment, a defect-free template 20 with high-precision patterning can be provided. Moreover, bottoms of the recesses 13a do not reach the substrate layer 11. Rather, bottom surfaces of the recesses 13a are formed of the first diamond-like carbon layer 12. Thus, sidewalls and bottoms of the recesses 13a, which form the contact surfaces with an imprint material (described hereafter), are formed of diamond-like carbon. Diamond-like carbon has a high level of hardness, a low friction coefficient, excellent release properties, and can reduce pattern defects at release.

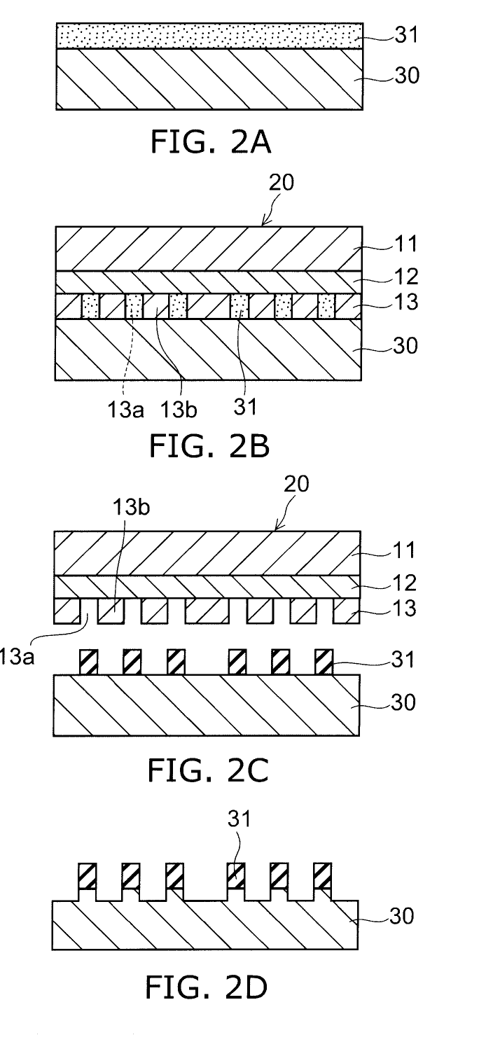

Next, a manufacturing method for a semiconductor device utilizing the template 20 of this embodiment will be described with reference to FIGS. 2A to 2D.

First, as illustrated in FIG. 2A, an imprint material 31 in an uncured state is supplied to a surface of a process target 30. The process target 30 is the substrate itself, or any of various types of film formed on the substrate. The imprint material 31 is, for instance, a heat-curable or photo-curable resin material.

Next, as illustrated in FIG. 2B, the imprint material 31 is caused to contact the above-described recess and protrusion pattern of the template 20, and the template 20 is pressed into the process target 30.

In this state, the imprint material 31 is cured by applying heat, ultraviolet light or the like to the imprint material 31. After curing, the imprint material 31 is released from the template 20, as shown in FIG. 2C. Accordingly, an inverted pattern of the recess and protrusion pattern formed on the template 20 is imprinted on the imprint material 31.

Next, using the patterned imprint material 31 as a mask, the process target 30 is selectively etched. As a result, the recess and protrusion pattern is formed on the surface of the process target 30, as shown in FIG. 2D.

In removing the defect 13c, when the etching proceeds to a first diamond-like carbon layer 12 below the defect 13c, a recess 13a deeper than another recess 13a is formed. That is, depth fluctuation of the plurality of recesses 13a formed in the template 20 occurs.

The deep recess 13a tends to cause a lack of filling of the imprint material 31. This produces a pattern defect.

Alternatively, when the imprint material 31 is filled to reach the bottom of the deep recess 13a, a contact area of the deep recess 13a with the imprint material 31 increases. The recess 13a having a larger contact area with the imprint material 31 than other recesses 13a has a local high adhesion between the recess 13a and the imprint material 31, and thus the imprint material is easy to be torn in separation.

In this embodiment, the endpoint of the defect removal can be surely detected using the method described above. Therefore, the etching of the first diamond-like carbon layer 12 can be suppressed. As a result, the template 20 having multiple recesses 13a with a homogeneous depth can be fabricated. The depth of the multiple recesses 13a is homogeneous. Therefore, the contact area of the template 20 with the imprint material 31 is homogeneous, and thus a pattern defect in the separation can be suppressed.

Note that to remove the defect 13c, etching in which Auger electrons are not emitted, such as ion beam etching, may be performed. To detect the endpoint in this case, irradiation with an electron beam or the like is performed during or after the etching to cause emission of Auger electrons. Here too, the end point of the defect to be corrected can be detected from the energy spectra of the Auger electrons in the manner described above. Note also that this method is not limited to defect removal, but may also be used to detect an endpoint during the etching that forms the recesses 13a.

Further, the method of this embodiment is not limited to the detection of endpoints of processing such as a defect removal or etching, but can also be used to identify, for example, which diamond-like carbon layer is currently being etched or irradiated with the electron beam or the like, and, in addition, which surface has been exposed by the etching. For example, the correlation between the peak position and half width of the above-described energy spectrum of the 1s orbitals and the mixture ratio of the sp²-bonded carbon atoms to the sp³-bonded carbon atoms are found in advance. Then, by comparing the peak position and half width obtained by measuring the Auger electrons with the correlation, it is possible to identify which layer is currently undergoing processing. Thereby, it is possible to find how far the defect removal has progressed or how far the etching of the recesses 13a has progressed.

Determining the processing endpoint or the amount of progress of the processing from the peak position and the half width of the energy spectrum of the 1s orbitals may be performed automatically by a computer or manually by a person looking at the acquired peak position and half width.

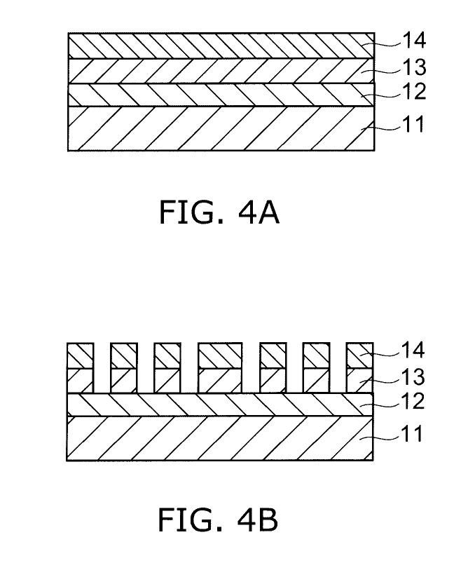

Note that the number of layers in the plurality of diamond-like carbon layers on the substrate layer 11 is not limited to two layers, and may be three layers, as illustrated in FIG. 4A.

This blank has a structure with a first diamond-like carbon layer 12, a second diamond-like carbon layer 13, and a third diamond-like carbon layer 14 stacked sequentially on a substrate layer 11.

For instance, in the first diamond-like carbon layer 12, the mixture ratio of the sp²-bonded carbon atoms to the sp³-bonded carbon atoms is substantially 1. In the second diamond-like carbon layer 13, the sp³-bonded carbon atom content is greater than the sp²-bonded carbon atom content, making the second diamond-like carbon layer 13 sp³-bonded carbon rich. In the third diamond-like carbon layer 14, the sp²-bonded carbon atom content is greater than the sp³-bonded carbon atom content, making the third diamond-like carbon layer 14 sp²-bonded carbon rich.

The template illustrated in FIG. 4B is obtained by forming a desired recess and protrusion pattern in the third diamond-like carbon layer 14 and the second diamond-like carbon layer 13 of the blank.

In this embodiment too, the above-described method can be applied to remove defects and etch recesses. Specifically, when the layer being processed shifts from the sp²-bonded carbon-rich third diamond-like carbon layer 14 to the sp³-bonded carbon-rich second diamond-like carbon layer 13, the peak position of the 1s orbitals shifts away from the peak position of the sp² orbitals towards the peak position of the sp³ orbitals. By setting a threshold value for the peak position, TAT can be reduced by increasing processing speed when the peak position of the is orbitals is on the sp² orbital peak position side with respect to the threshold value, and the precision with which the energy spectrum is detected can be improved by reducing processing speed when the peak position of the 1s orbitals is on the sp³ orbital peak position side with respect to the threshold value.

When the processing proceeds further and the surface of the first diamond-like carbon layer 12, which has a mixture ratio of the sp²-bonded carbon atoms to the sp³-bonded carbon atoms of substantially 1, is exposed, the peak position of the is orbitals shifts away from the peak position of the sp² orbitals towards a position that is approximately midway between the peak position of the sp² orbitals and the peak position of the sp³ orbitals. Further, the half width of the peak of the 1s orbitals becomes smaller.

By setting a threshold value for the peak position and/or the half width and monitoring their changes, the processing endpoint can be detected. Once the endpoint is detected, irradiation with the electron beam or etching can be stopped. As a result, damage to the first diamond-like carbon layer 12, which is not the target of the correction or etching, can be reduced.

Note that four or more diamond-like carbon layers may be formed. In cases when three layers or more are formed, to detect the interfaces between adjacent layers in the stacking direction, all layers need not have different mixture ratios of the sp²-bonded carbon atoms to the sp³-bonded carbon atoms. The only requirement is that any two adjacent layers have different mixture ratios.

The plurality of diamond-like carbon layers is not limited to the above-described combinations. For instance, the two-layer structure may be a combination of an sp² orbital rich layer and an sp³ orbital rich layer. With such a combination, the change in the spectral width of the 1s orbitals (the half width) when the processing reaches the interface between the two layers is not so large, but the change in peak position is large. Note that when processing reaches the interface in a structure including a layer with a mixture ratio of sp²-bonded carbon atoms to sp³-bonded carbon atoms of substantially 1 and an sp² orbital rich layer or an sp³ orbital rich layer, there will be a large change in both the spectral width and the peak position of the 1s orbitals (the half width).

Further, sp² orbital rich diamond-like carbon layers have a comparatively low friction coefficient, and a high level of releasability can therefore be expected when sp² orbital rich diamond-like carbon layer is exposed at the bottoms of the recesses 13a.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. An imprint blank comprising:
a substrate layer; and
a plurality of diamond-like carbon layers stacked on the substrate layer, and having a mixture ratio of carbon atoms forming sp² hybrid orbitals to carbon atoms forming sp³ hybrid orbitals differing between adjacent layers in a stacking direction.

2. The blank according to claim 1, wherein the plurality of diamond-like carbon layers include a stacked structure of a layer having the mixture ratio of substantially one with a layer having a carbon atom content forming the sp² hybrid orbitals greater than a carbon atom content forming the sp³ hybrid orbitals or a layer having the carbon atom content forming the sp³ hybrid orbitals greater than the carbon atom content forming the sp² hybrid orbitals.

3. An imprint template comprising:
a substrate layer; and
a plurality of diamond-like carbon layers stacked on the substrate layer, and having a mixture ratio of carbon atoms forming sp² hybrid orbitals to carbon atoms forming sp³ hybrid orbitals differing between adjacent layers in a stacking direction,
a pattern of a recess and a protrusion being formed in at least an uppermost layer of the plurality of diamond-like carbon layers.

4. The template according to claim 3, wherein the plurality of diamond-like carbon layers include a stacked structure of a layer having the mixture ratio of substantially one with a layer having a carbon atom content forming the sp² hybrid orbitals greater than a carbon atom content forming the sp³ hybrid orbitals or a layer having the carbon atom content forming the sp³ hybrid orbitals greater than the carbon atom content forming the sp² hybrid orbitals.

5. The template according to claim 3, wherein the recess does not reach the substrate layer, and a sidewall and a bottom of the recess are made of diamond-like carbon.

6. The template according to claim 5, wherein the bottom of the recess has a carbon atom content forming the sp² hybrid orbitals larger than a carbon atom content forming the sp³ hybrid orbitals.

7. A method for manufacturing an imprint template comprising:
forming a plurality of diamond-like carbon layers on a substrate layer, the plurality of diamond-like carbon layers having a mixture ratio of carbon atoms forming sp² hybrid orbitals to carbon atoms forming sp³ hybrid orbitals differing between adjacent layers in a stacking direction;
causing emission of Auger electrons by irradiating the diamond-like carbon layers with a radiation beam;
acquiring an energy spectrum of the Auger electrons; and
identifying the diamond-like carbon layers being irradiated with the radiation beam based on the energy spectrum.

8. The method according to claim 7, wherein
the plurality of diamond-like carbon layers are formed by chemical vapor deposition (CVD) method, and
the mixture ratio is controlled by a condition of the CVD.

9. The method according to claim 7, wherein the energy spectrum is an energy spectrum of 1s orbitals of carbon atoms contained in the diamond-like carbon layers being irradiated with the radiation beam.

10. The method according to claim 9, wherein the diamond-like carbon layers are identified based on a peak position in the energy spectrum of the 1s orbitals.

11. The method according to claim 9, wherein the diamond-like carbon layers are identified based on a spectral width of the energy spectrum of the is orbitals.

12. The method according to claim 7, wherein the diamond-like carbon layers are selectively removed simultaneously with the irradiation with the radiation beam.

13. The method according to claim 12, wherein
an etchant gas is supplied to a surface of the diamond-like carbon layers simultaneously with the irradiation with the radiation beam, and
carbon in the diamond-like carbon layers is removed by causing the carbon to react with the etchant gas to vaporize.

14. The method according to claim 12, wherein irradiation with the radiation beam is stopped based on the energy spectrum.

15. The method according to claim 7, further comprising:
etching selectively removing the diamond-like carbon layers,
a surface layer being exposed by the etching being identified by irradiating an etched portion with the radiation beam and acquiring the energy spectrum of the Auger electrons.

16. The method according to claim 15, wherein the etching is stopped based on the energy spectrum.
